(19) United States
(12) Patent Application Publication
(10) Pub. No.: US 2018/0085280 A1
(43) Pub. Date: Mar. 29, 2018

(54) WALKING ASSISTANCE APPARATUS AND ITS CONTROL METHOD

(71) Applicant: TOYOTA JIDOSHA KABUSHIKI KAISHA, Toyota-shi (JP)

(72) Inventors: Hiroshi SHIMADA, Tajimi-shi (JP); lssei NAKASHIMA, Toyota-shi (JP); Masayuki IMAIDA, Ichinomiya-shi (JP)

(73) Assignee: TOYOTA JIDOSHA KABUSHIKI KAISHA, Toyota-shi (JP)

(21) Appl. No.: 15/671,756

(22) Filed: Aug. 8, 2017

(30) Foreign Application Priority Data
Sep. 28, 2016 (JP) 2016-190364

(51) Int. Cl. A61H 3/00; A63B 21/00; A63B 23/035; A61H 1/02

(52) U.S. Cl. CPC A61H 3/00; A63B 21/0004; A63B 21/00181; A63B 21/4011; A63B 23/03508; A61H 1/024; A61H 2201/5069; A61H 2003/007; A61H 2201/164; A61H 2201/165; A61H 2201/1676; A61H 2201/5007; A61H 2201/5071; A61H 2201/1215

(57) ABSTRACT

A walking assistance apparatus includes frames, at least one leg joint part that connects the frames, a drive unit for driving the leg joint part, a controller for controlling the drive unit so that the drive unit generates a first driving force to assist the walking motion, and an acquisition unit for acquiring an assisting level based on which a magnitude of an assisting force of the drive unit is determined when the walking motion is assisted. The controller controls the first driving force of the drive unit according to the acquired assisting level. The controller controls the drive unit so that the drive unit generates a driving force when the acquired assisting level is equal to or lower than a predetermined level, the driving force being obtained by reducing the first driving force by a second driving force corresponding to a friction force caused in the leg joint part.

### CROSS REFERENCE TO RELATED APPLICATIONS

This application is based upon and claims the benefit of priority from Japanese patent application No. 2016-190364, filed on Sep. 28, 2016, the disclosure of which is incorporated herein in its entirety by reference.

### BACKGROUND

The present disclosure relates to a walking assistance apparatus for assisting walking performed by a user, and its control method. A walking assistance apparatus that is attached to a user's leg and assists walking motions in which the leg repeats a leg-standing state and a leg-idling state, and includes a plurality of frames, at least one leg joint part that connects each of the plurality of frames so that the frame can be rotationally moved, drive means for driving the leg joint part, and control means for controlling the drive means so as to assist the walking motion has been known (see Japanese Patent Application No. 2015-223294).

It should be noted that, for example, it is desirable to reduce the assisting level based on which the magnitude of the assisting force applied by the drive means is determined when the above-described walking motion is assisted as appropriate according to the user's recovery level and thereby to stimulate the user to walk on his/her own. In such a case, the user perceives that he/she has failed in his/her walking when his/her leg cannot support his/her own weight during the walking motion, and hence the leg bends under the weight and the leg joint part such as a knee joint part or an ankle joint part is bent.

### SUMMARY

The present inventors have found the following problem. That is, when the assisting level is adjusted to a low level and the assisting force of the drive means is thereby reduced, the aforementioned bending motion could be prevented (or reduced) by a friction force generated in the leg joint part. As a result, the user is less likely to perceive the failure in his/her walking.

The present disclosure has been made in view of the above-described problem and a main object thereof is to provide a walking assistance apparatus and its control method capable of naturally inducing a bending motion of a leg joint part and thereby enabling a user to easily perceive a failure in his/her walking.

A first exemplary aspect to achieve the above-described object is a walking assistance apparatus configured to be attached to a user's leg and assist a walking motion in which the leg repeats a leg-standing state and a leg-idling state, the walking assistance apparatus including: a plurality of frames; at least one leg joint part that connects each of the plurality of frames so that the frames can be rotationally moved relative to each other; drive means for driving the leg joint part; control means for controlling the drive means so that the drive means generates a first driving force and thereby assists the walking motion; and acquisition means for acquiring an assisting level based on which a magnitude of an assisting force of the drive means is determined when the walking motion is assisted, in which the control means controls the first driving force of the drive means according to the assisting level acquired by the acquisition means, and the control means controls the drive means so that the drive means generates a driving force when the assisting level acquired by the acquisition means is equal to or lower than a predetermined level, the driving force being obtained by reducing the first driving force by a second driving force corresponding to a friction force caused in the leg joint part.

In this aspect, the control means may control the drive means so that the drive means generates a driving force in a predetermined period when the assisting level acquired by the acquisition means is equal to or lower than the predetermined level, the predetermined period being within a leg-standing period of the walking motion and including a timing at which an angular speed of the leg joint part becomes zero, the driving force being obtained by reducing the first driving force by a second driving force corresponding to a static friction force caused in the leg joint part.

In this aspect, the control means may control the drive means so that the drive means generates the first driving force in the predetermined period within a leg-idling period of the walking motion, and control the driving means so that the drive means generates a driving force in a period other than the predetermined period in the leg-standing period and the leg-idling period, the driving force being obtained by adding a third driving force corresponding to viscous friction and kinetic friction caused in the leg joint part to the first driving force.

In this aspect, the leg joint part may be at least one of a knee joint part and an ankle joint part.

Another exemplary aspect to achieve the above-described object may be a control method for a walking assistance apparatus configured to be attached to a user's leg and assist a walking motion in which the leg repeats a leg-standing state and a leg-idling state, the walking assistance apparatus including: a plurality of frames; at least one leg joint part that connects each of the plurality of frames so that the frames can be rotationally moved relative to each other; drive means for driving the leg joint part; control means for controlling the drive means so that the drive means generates a first driving force and thereby assists the walking motion; and acquisition means for acquiring an assisting level based on which a magnitude of an assisting force of the drive means is determined when the walking motion is assisted in a stepwise manner, in which the control means controls the first driving force of the drive means according to the assisting level acquired by the acquisition means, and the control method includes controlling the drive means so that the drive means generates a driving force when the assisting level acquired by the acquisition means is equal to or lower than a predetermined level, the driving force being obtained by reducing the first driving force by a second driving force corresponding to a friction force caused in the leg joint part.

According to the present disclosure, it is possible to provide a walking assistance apparatus and its control method capable of naturally inducing a bending motion of a leg joint part and thereby enabling a user to easily perceive a failure in his/her walking.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a perspective view showing a schematic configuration of a walking assistance apparatus according to a first embodiment of the present disclosure;

FIG. 2 is a block diagram showing a schematic system configuration of the walking assistance apparatus according to the first embodiment of the present disclosure;

FIG. 3 is a block diagram showing a schematic configuration of a control device according to the first embodiment of the present disclosure;

FIG. 4 is a flowchart showing a control method for the walking assistance apparatus according to the first embodiment of the present disclosure;

FIG. 5 is a block diagram showing a schematic system configuration of a control device according to a second embodiment of the present disclosure;

FIG. 6 is a graph showing a relation between a knee joint angular speed and a mechanical friction force in first friction compensation control;

FIG. 7 is a graph showing a relation between a knee joint angular speed and a mechanical friction force in second friction compensation control;

FIG. 8 is a flowchart showing a flow in a control method for a walking assistance apparatus according to the second embodiment of the present disclosure;

FIG. 9 is a diagram showing a leg-standing period and a leg-idling period of a leg; and

FIG. 10 is a block diagram showing a schematic system configuration of a walking assistance apparatus according to a third embodiment of the present disclosure.

### DESCRIPTION OF EMBODIMENTS

### First Embodiment

Embodiments according to the present disclosure are explained hereinafter with reference to the drawings.

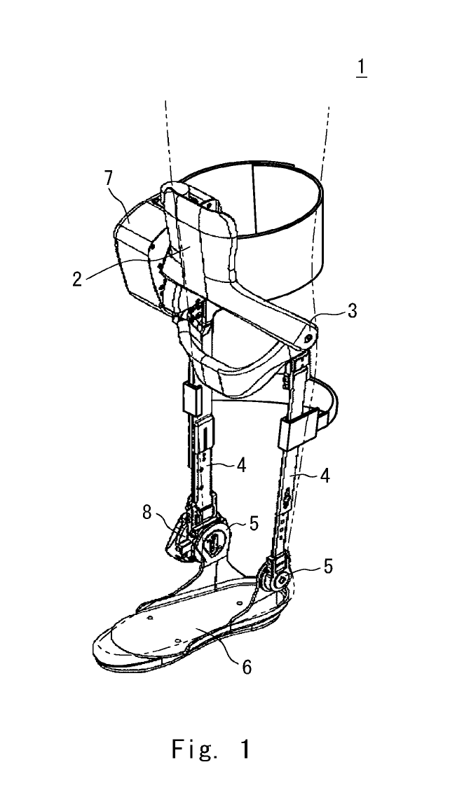

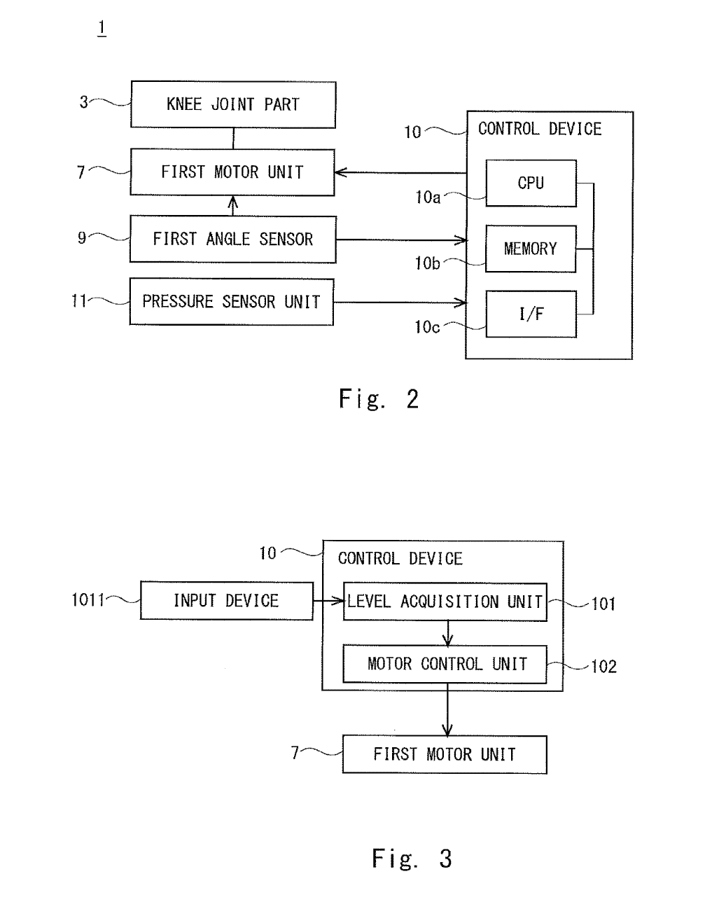

FIG. 1 is a perspective view showing a schematic configuration of a walking assistance apparatus according to a first embodiment of the present disclosure. FIG. 2 is a block diagram showing a schematic system configuration of the walking assistance apparatus according to the first embodiment of the present disclosure.

A walking assistance apparatus 1 according to the first embodiment is attached to, for example, a leg (such as a diseased leg) of a user who performs walking, and assists walking motions in which the leg repeats a leg-standing state and a leg-idling state. The walking assistance apparatus 1 includes an upper thigh frame 2, a lower thigh frame 4 connected to the upper thigh frame 2 through a knee joint part 3, a foot frame 6 connected to the lower thigh frame 4 through an ankle joint part 5, a first motor unit 7 that rotationally drives the knee joint part 3, an adjustment mechanism 8 that adjusts a movable range of the ankle joint part 5, a first angle sensor 9 that detects a knee joint angle, and a control device 10 that controls the first motor unit 7. Note that the above-described configuration of the walking assistance apparatus 1 is merely an example and the configuration is not limited to this example. The upper thigh frame 2, the lower thigh frame 4, and the foot frame 6 are specific examples of the frames.

The upper thigh frame 2 is attached to the upper thigh of the user's leg. The lower thigh frame 4 is attached to the lower thigh of the user's leg. The foot frame 6 is attached to the user's foot.

A pressure sensor unit 11 that detects a pressure (or a load) exerted on the sole of a user's foot is provided in the foot frame 6. The pressure sensor unit 11 includes a plurality of vertical pressure sensors each of which detects a vertical pressure exerted on the sole of the user's foot. The pressure sensor unit 11 is connected to the control device 10 through a wire or wirelessly and outputs a detected pressure value to the control device 10.

The first motor unit 7 is a specific example of the drive means. The first motor unit 7 is formed by, for example, a motor, a reduction mechanism, and the like. The first motor unit 7 is connected to the control device 10 through a wire or wirelessly. The first motor unit 7 generates an assisting force for the knee joint part 3 according to a control signal output from the control device 10 and thereby assists the user's walking.

The first angle sensor 9 is disposed in the knee joint part 3. The first angle sensor 9 is, for example, a potentiometer or a rotary encoder. The first angle sensor 9 detects an angle of the knee joint part 3, i.e., an angle between the upper thigh frame 2 and the lower thigh frame 4 (hereinafter referred to as a “knee joint angle”). The first angle sensor 9 is connected to the control device 10 through a wire or wirelessly and outputs a detected knee joint angle to the control device 10. The control device 10 calculates, for example, an angular speed of the knee joint part 3 (hereinafter referred to as a “knee joint angular speed”) by differentiating the knee joint angle output from the first angle sensor 9 once (i.e., calculates a first-order differentiation of the knee joint angle).

The control device 10 is formed by, for example, hardware mainly using a microcomputer including a CPU (Central Processing Unit) 10a that performs arithmetic processing, control processing, and so on, a memory 10b composed of a ROM (Read Only Memory) and a RAM (Random Access Memory) that stores an arithmetic program to be executed by the CPU 10a and various data, and an interface unit (I/F) 10c that externally receives and outputs signals, and so on. The CPU 10a, the memory 10b, and the interface unit 10c are connected with each other through a data bus or the like. Note that although the control device 10 and the first motor unit 7 are formed independently of each other, the control device 10 and the first motor unit 7 may instead be formed integrally with each other.

FIG. 3 is a block diagram showing a schematic configuration of the control device according to the first embodiment. The control device 10 according to the first embodiment includes a level acquisition unit 101 that acquires an assisting level based on which the assisting force of the first motor unit 7 is determined when the user's walking motion is assisted, and a motor control unit 102 that controls the driving of the first motor unit 7 according to the assisting level.

The level acquisition unit 101 is a specific example of the acquisition means. The level acquisition unit 101 acquires the assisting level through an input device 1011 or the like. The input device 1011 is, for example, a PC (Personal Computer), a mobile terminal (such as a smartphone), a keyboard, a mouse, or the like. The assisting level is set so that, for example, its numerical value (such as levels 1 to 10) decreases in a stepwise manner as the user's recovery level increases (i.e., as the user's diseased leg recovers). Note that the level acquisition unit 101 may acquire an assisting level for each user that is defined in advance in the memory 10b or the like.

The motor control unit 102 is a specific example of the control means. The motor control unit 102 controls the driving of the first motor unit 7 based on the knee joint angle output from the first angle sensor 9 and thereby assists the user's walking motion. The motor control unit 102 controls the first motor unit 7 so that it generates a first driving force and thereby assists the user's walking motion. For example, the motor control unit 102 makes the first motor unit 7 generate the first driving force so that the knee joint angle detected by the first angle sensor 9 follows the knee joint angle in graph information that is defined (or stored) in advance in the memory 10b or the like. In the graph information, for example, the knee joint angle is defined in such a manner that in a leg-idling period during user's gait motions, the knee joint angle monotonously increases from a start of a leg-idling state to a maximum leg-idling bending state and monotonously decreases from the maximum leg-idling bending state to an end of the leg-idling state. In the graph information, the knee joint angle also changes in a leg-standing period in a manner similar to that in the leg-idling period. Further, the leg-standing period and the leg-idling period are alternately repeated.

Further, the motor control unit 102 controls the first driving force of the first motor unit 7 according to the assisting level acquired by the level acquisition unit 101. For example, the motor control unit 102 performs control so that the first driving force of the first motor unit 7 decreases as the assisting level acquired by the level acquisition unit 101 decreases. In this manner, when the assisting level is reduced as the user's recovery level increases, the first driving force of the first motor unit 7 is reduced. Therefore, since the assisting force of the first motor unit 7 that is used to assist the user's walking motion is reduced, the user can be stimulated to walk on his/her own.

It should be noted that when the assisting level is reduced as appropriate according to the user's recovery level as described above, the user perceives that he/she has failed in his/her walking when, for example, his/her leg cannot support his/her own weight, and hence the leg bends the weight and the knee joint part is bent.

However, when the assisting level is adjusted to a low level and the assisting force of the first motor unit is thereby reduced, the aforementioned bending motion could be prevented (or reduced) by a friction force generated in the knee joint part. As a result, the user is less likely to perceive the failure in his/her walking.

To cope with this, in the walking assistance apparatus 1 according to the first embodiment, the motor control unit 102 controls the first motor unit 7 so that it generates a driving force that is obtained by reducing the first driving force by a second driving force corresponding to a friction force caused in the knee joint part 3 when the assisting level acquired by the level acquisition unit 101 is low, i.e., equal to or lower than a predetermined level.

In this way, even when the assisting level is low and hence the above-described bending motion is prevented by the friction force caused in the knee joint part 3, it is possible to naturally induce the bending motion of the knee joint part 3 by making the first motor unit 7 generate the driving force that is obtained by reducing the first driving force by the second driving force corresponding to the friction force caused in the knee joint part 3. As a result, the user can easily perceive a failure in his/her walking.

The motor control unit 102 performs friction compensation control for compensating for the friction force caused in the knee joint part 3 for the first motor unit 7 when the assisting level acquired by the level acquisition unit 101 is equal to or lower than the predetermined level. The motor control unit 102 controls the first motor unit 7 so that it generates a driving force that is obtained by reducing the first driving force by a second driving force corresponding to mechanical friction in the knee joint part 3. Note that the aforementioned mechanical friction is, for example, viscous friction, kinetic friction, static friction, or the like that are caused in the knee joint part 3 when it is rotationally moved. The predetermined level is, for example, obtained by experimentally obtaining a level at which the bending motion of the knee joint part is prevented (or reduced) in advance and stored in the memory 10b or the like.

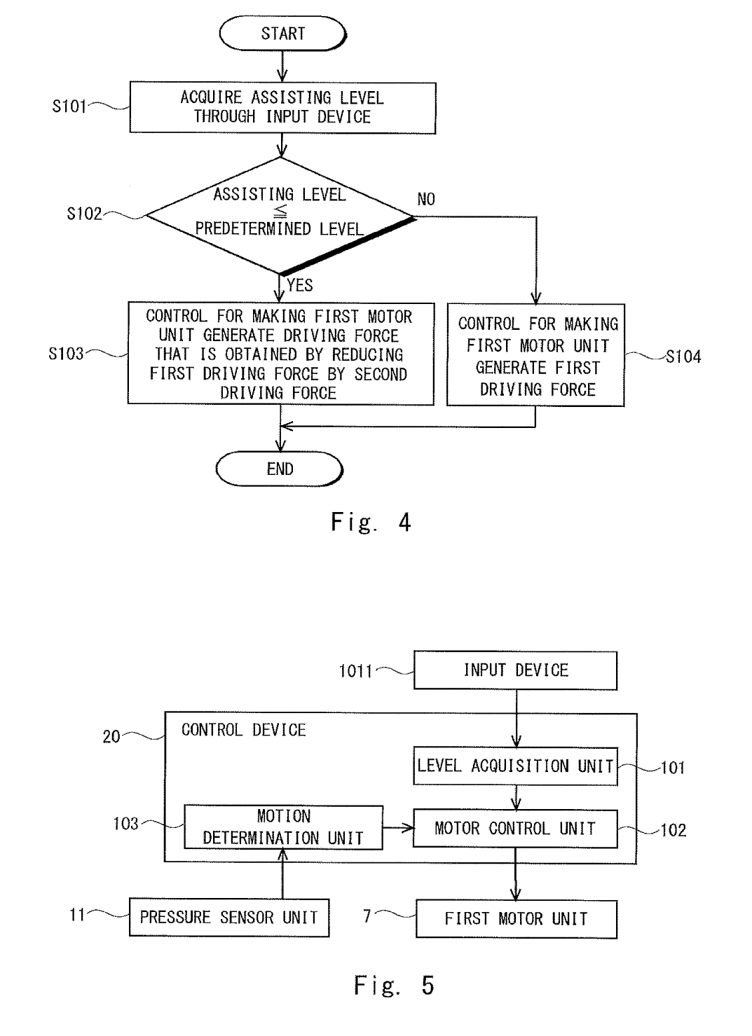

FIG. 4 is a flowchart showing a control method for the walking assistance apparatus according to the first embodiment.

The level acquisition unit 101 acquires an assisting level through an input device or the like and outputs the acquired assisting level to the motor control unit 102 (step S101).

The motor control unit 102 determines whether or not the assisting level output from the level acquisition unit 101 is equal to or lower than a predetermined level (step S102). When the motor control unit 102 determines that the assisting level output from the level acquisition unit 101 is equal to or lower than the predetermined level (Yes at step S102), the motor control unit 102 controls the first motor unit 7 so that it generates a driving force that is obtained by reducing the first driving force by a second driving force corresponding to a friction force caused in the knee joint part 3 (step S103). On the other hand, when the motor control unit 102 determines that the assisting level output from the level acquisition unit 101 is higher than the predetermined level (No at step S102), the motor control unit 102 controls the first motor unit 7 so that it generates the first driving force (step S104).

As described above, in the walking assistance apparatus 1 according to the first embodiment, the motor control unit 102 controls the first motor unit 7 so that it generates the driving force that is obtained by reducing the first driving force by the second driving force corresponding to the friction force caused in the knee joint part 3 when the assisting level acquired by the level acquisition unit 101 is low, i.e., equal to or lower than the predetermined level. In this way, even when the assisting level is low, it is possible to naturally induce the bending motion of the knee joint part 3 and thereby to enable the user to easily perceive a failure in his/her walking.

### Second Embodiment

A large static friction force (a maximum static friction force) is caused in the knee joint part 3 at a timing at which the angular speed of the knee joint part becomes zero in the leg-standing period of the walking motion. When the assisting level is low, i.e., equal to or lower than the predetermined level, in particular, this static friction force significantly affects the user's walking motion. This static friction force could prevent the bending motion of the knee joint part and hence the user is less likely to perceive a failure in his/her walking.

To cope with this, in a walking assistance apparatus 1 according to a second embodiment of the present disclosure, the motor control unit 102 controls the first motor unit 7 so that it generates a driving force that is obtained by reducing the first driving force by a second driving force corresponding to a static friction force caused in the knee joint part 3 in a predetermined period which is within the leg-standing period of the walking motion and includes a timing at which the angular speed of the knee joint part 3 becomes zero when the assisting level acquired by the level acquisition unit 101 is low, i.e., equal to or lower than the predetermined level.

In this way, even when the bending motion of the knee joint part 3 is prevented due to a static friction force or the like caused in the knee joint part 3 in the predetermined period including the timing at which the angular speed of the knee joint part becomes zero, it is possible to naturally induce the bending motion of the knee joint part 3 by making the first motor unit 7 generate the driving force that is obtained by reducing the first driving force by the second driving force corresponding to the static friction force caused in the knee joint part 3. As a result, the user can easily perceive a failure in his/her walking.

FIG. 5 is a block diagram showing a schematic system configuration of a control device according to the second embodiment. A control device 20 according to the second embodiment further includes a motion determination unit 103 that determines whether the leg is in a leg-idling period or a leg-standing period in addition to the configuration of the control device 10 according to the above-described first embodiment.

The motion determination unit 103 determines whether the leg is in the leg-standing period or the leg-idling period based on, for example, a pressure value on the sole output from the pressure sensor unit 11. Not that, for example, the leg-idling period means a period during which an idling leg is extending from a bent state and the leg-standing period means a period which starts when the extending of the idling leg is completed and during which the leg is in a leg-standing state.

When the pressure value output from the pressure sensor unit 11 is equal to or larger than a pressure threshold, the motion determination unit 103 determines that the leg is in the leg-standing period. On the other hand, when the pressure value output from the pressure sensor unit 11 is smaller than the pressure threshold, the motion determination unit 103 determines that the leg is in the leg-idling period. In this way, it is possible to easily determine whether the leg is in the leg-standing period or the leg-idling period by using the pressure sensor unit 11 disposed in the walking assistance apparatus.

Note that the above-described pressure threshold is obtained by, for example, measuring pressure values in the leg-standing period and in the leg-idling period in advance and stored in the above-described memory 10b or the like.

The motion determination unit 103 may calculate a center position of a pressure exerted on trainee's sole based on the pressure value output from the pressure sensor unit 11 and determine whether the leg is in the leg-standing period or the leg-idling period based on the calculated pressure center position. For example, an area of the pressure center position in which the leg is in the leg-standing period and an area of the pressure center position in which the leg is in the leg-idling period are obtained in advance. Then, the motion determination unit 103 determines whether the leg is in the leg-standing period or the leg-idling period by determining which of the areas for the leg-standing period and the leg-idling period the trainee's pressure center position, which is calculated based on the pressure value output from the pressure sensor unit 11, is in.

The motion determination unit 103 may determine whether the leg is in the leg-standing period or the leg-idling period based on a change in the knee joint angle over time detected by the first angle sensor 9. More specifically, the motion determination unit 103 may determine that the leg is in the leg-standing period or in the leg-idling period when the motion determination unit 103 determines that the detected knee joint angle enters a change area corresponding to the leg-standing period or corresponding to the leg-idling period based on a change in the knee joint angle over time detected by the first angle sensor 9. Note that the above-described method for determining the leg-standing period and the leg-idling period by the motion determination unit 103 is an example and the method is not limited to the above-described method.

The motor control unit 102 performs friction compensation control for the first motor unit 7 according to a determination result of the motion determination unit 103. When the motion determination unit 103 determines that the leg is in the leg-idling period, the motor control unit 102 performs (I) first friction compensation control for the first motor unit 7. Further, when the motion determination unit 103 determines that the leg is in the leg-standing period, the motor control unit 102 performs (II) second friction compensation control for the first motor unit 7.

(I) First Friction Compensation Control

In the leg-idling period, the motor control unit 102 calculates a mechanical friction force T_{f} in the knee joint part 3 based on the below-shown Expression (1) in which a kinetic friction force and a viscous friction force in the knee joint part 3 are taken into consideration. Then, the motor control unit 102 calculates a third driving force corresponding to the mechanical friction force T_{f} by multiplying the calculated mechanical friction force T_{f} by a predetermined coefficient. It is possible to compensate for a loss in the first driving force due to the kinetic friction force and the viscous friction force in the knee joint part 3 by the third driving force in which the kinetic friction force and the viscous friction force in the knee joint part 3 are taken into consideration.

It is assumed that the third driving force corresponding to the mechanical friction force T_{f} includes not only the third driving force equal to the mechanical friction force T_{f}, but also third driving forces larger or smaller than the mechanical friction force T_{f} used for reducing a loss in the driving force of the first motor unit 7.

T_{f}=T_{dynamic}+K_{f}θ_{V}(θ_{V}>0)

T_{f}=−T_{dynamic}+K_{f}θ_{V}(θ_{V}<0) (1)

The term “T_{dynamic}” is a kinetic friction force in the knee joint part 3 and “K_{f}θ_{V}” is a viscous friction force in the knee joint part 3. The constant “K_{f}” is a viscous friction coefficient and “θ_{V}” is a knee joint angular speed. The extending direction of the knee joint part 3 is defined as a positive direction and the bending direction thereof is defined as a negative direction.

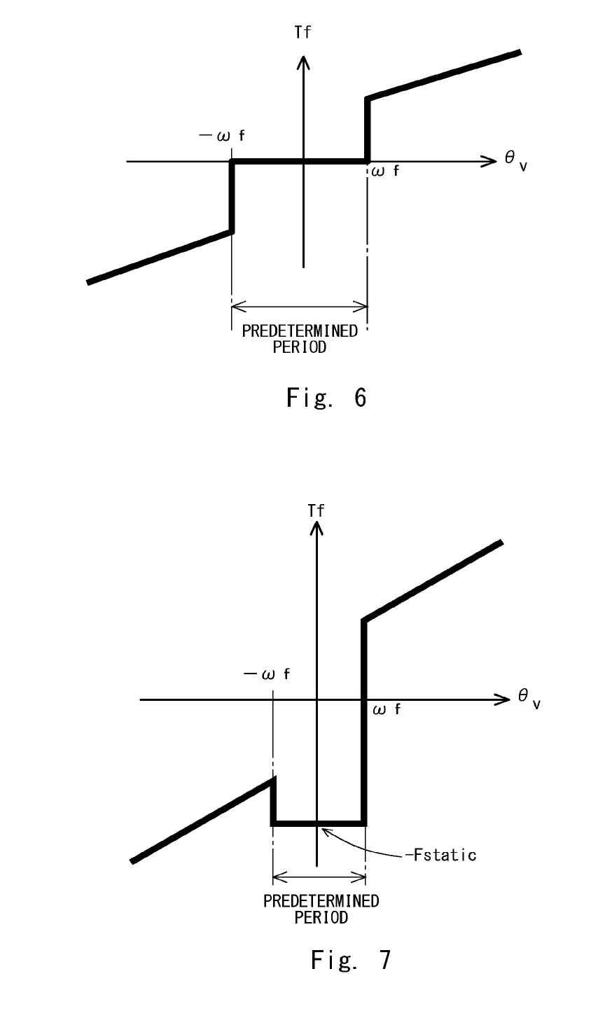

It should be noted that the torque control for the knee joint part 3 is significantly changed at a timing at which the knee joint angular speed θ_{V} becomes roughly zero. FIG. 6 is a graph showing a relation between the knee joint angular speed and the mechanical friction force in the first friction compensation control. As indicated by broken lines in FIG. 6, the positive/negative sign of the mechanical friction force T_{f} is changed around a point where the knee joint angular speed θ_{V} is zero (θ_{V}=0). Therefore, if the first motor unit 7 generates a driving force in a predetermined period around the timing at which the knee joint angular speed θ_{V} is roughly zero, hunting is likely to occur.

In the second embodiment, in order to prevent the above-described hunting, the motor control unit 102 suspends the control for adding the third driving force to the first driving force in the predetermined period including the timing at which the knee joint angular speed θ_{V} is roughly zero (e.g., a period expressed as “−ω_{f}≦θ_{V}≦ω_{f}”). Therefore, this predetermined period becomes a dead zone. For the predetermined period (−ω_{f}≦θ_{V}≦ω_{f}), values that are experimentally obtained in advance are stored in the memory 10b or the like.

For example, the mechanical friction force T_{f} is set to zero in the predetermined period including the timing at which the knee joint angular speed θ_{V} is zero (i.e., the period “−ω_{f}≦θ_{V}≦ω_{f}”). Therefore, the motor control unit 102 calculates the third driving force corresponding to the mechanical friction force T_{f} as zero.

When the above-described matters are summarized, in the first friction compensation control, the motor control unit 102 calculates a mechanical friction force T_{f} in the knee joint part 3 based on the below-shown Expression (2). The motor control unit 102 calculates a third driving force corresponding to the mechanical friction force T_{f} by multiplying the calculated mechanical friction force T_{f} by a predetermined coefficient. The motor control unit 102 controls the first motor unit 7 so that it generates a driving force that is obtained by adding the third driving force to the first driving force.

T_{f}=T_{dynamic}+K_{f}θ_{V}(θ_{V}>ω_{f})

T_{f}=−T_{dynamic}+Kₜθ_{V}(θ_{V}<−ω_{f})

T_{f}=0(−ω_{f}≦θ_{V}≦ω_{f}) (2)

(II) Second Friction Compensation Control

In the leg-standing period, the motor control unit 102 calculates a mechanical friction force T_{f} in the knee joint part 3 based on the above-shown Expression (1) as in the case of the above-described leg-idling period.

It should be noted that as described above, a large static friction force is caused at the timing at which the knee joint angular speed θ_{V} becomes roughly zero. This static friction force could prevent the bending motion of the knee joint part in the leg-standing period. When the assisting level is low, i.e., equal to or lower than a predetermined level, in particular, this static friction force significantly affects the user's walking motion.

To cope with this, in the second embodiment, when the assisting level acquired by the level acquisition unit 101 is equal to or lower than the predetermined level, the motor control unit 102 sets the mechanical friction force T_{f} to a value “−F_{static}” and calculates a second driving force corresponding to this mechanical friction force T_{f} in the predetermined period including the timing at which the knee joint angular speed θ_{V} becomes zero (i.e., the period “−ω_{f}≦θ_{V}≦ω_{f}”). By this second driving force, it is possible to naturally induce the bending motion of the knee joint part 3.

FIG. 7 is a graph showing a relation between the knee joint angular speed and the mechanical friction force in the second friction compensation control. As shown in FIG. 7, when the assisting level is equal to or lower than the predetermined level, the mechanical friction force T_{f} is set to the value “−F_{static}” (T_{f}=−F_{static}) in the predetermined period including the timing at which the knee joint angular speed θ_{V} becomes zero (θ_{V}=0) (i.e., the period “−ω_{f}≦θ_{V}≦ω_{f}”).

On the other hand, when the assisting level acquired by the level acquisition unit 101 is higher than the predetermined level, the motor control unit 102 sets the mechanical friction force T_{f} to zero and calculates a second driving force corresponding to this mechanical friction force T_{f} in the predetermined period including the timing at which the knee joint angular speed θ_{V} becomes zero (i.e., the period “−ω_{f}≦θ_{V}≦ω_{f}”).

When the above-described matters are summarized, in the second friction compensation control, the motor control unit 102 calculates a mechanical friction force T_{f} in the knee joint part 3 based on the below-shown Expression (3). The motor control unit 102 calculates a second or third driving force corresponding to the mechanical friction force T_{f} by multiplying the calculated mechanical friction force T_{f} by a predetermined coefficient. The motor control unit 102 controls the first motor unit 7 so that it generates a driving force that is obtained based on the second or third driving force and the first driving force.

T_{f}=T_{dynamic}+K_{f}θ_{V}(θ_{V}>ω_{f})

T_{f}=−T_{dynamic}+K_{f}θ_{V}(θ_{V}<−ω_{f})

T_{f}−F_{static}(−ω_{f}≦θ_{V}≦ω_{f}) and ((Assisting level)≦(Predetermined level))

T_{f}=0(−ω_{f}≦θ_{V}≦ω_{f}) and ((Assisting level)>(Predetermined level)) (3)

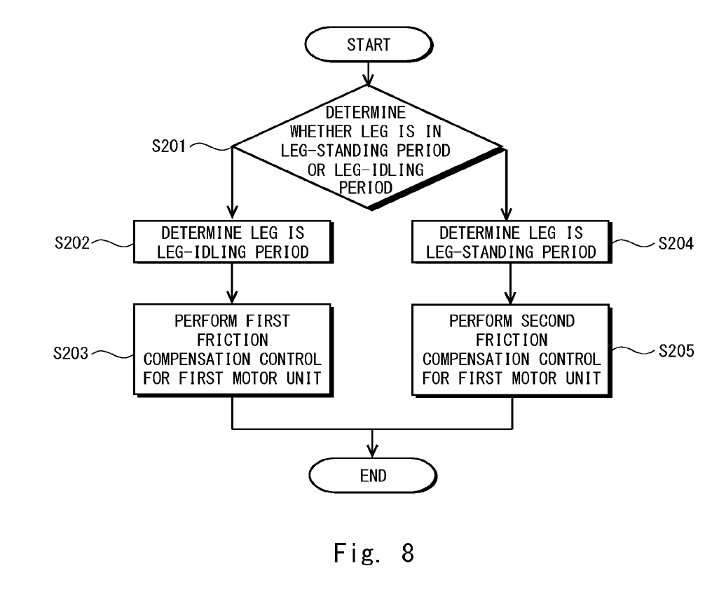

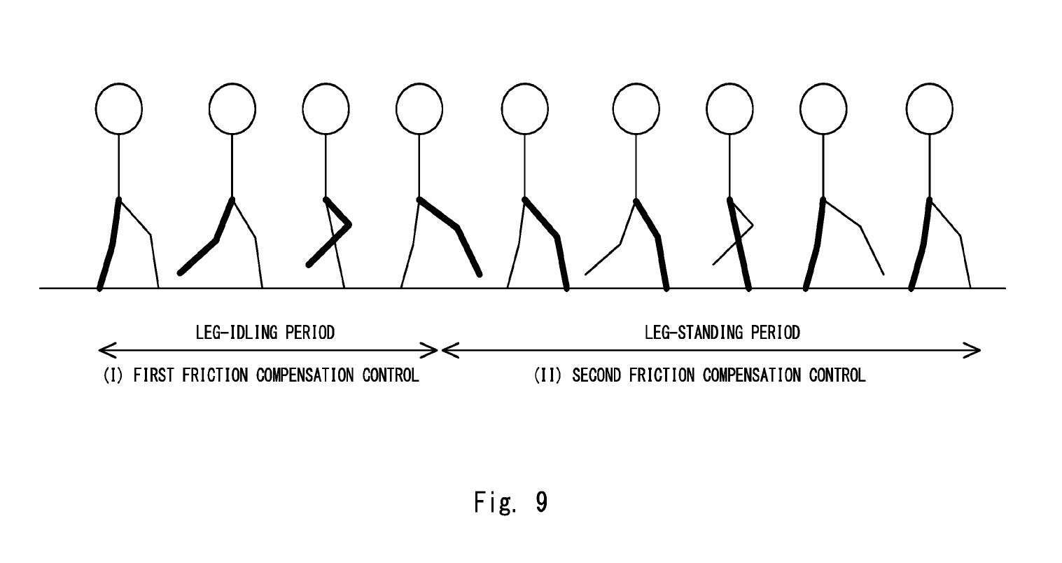

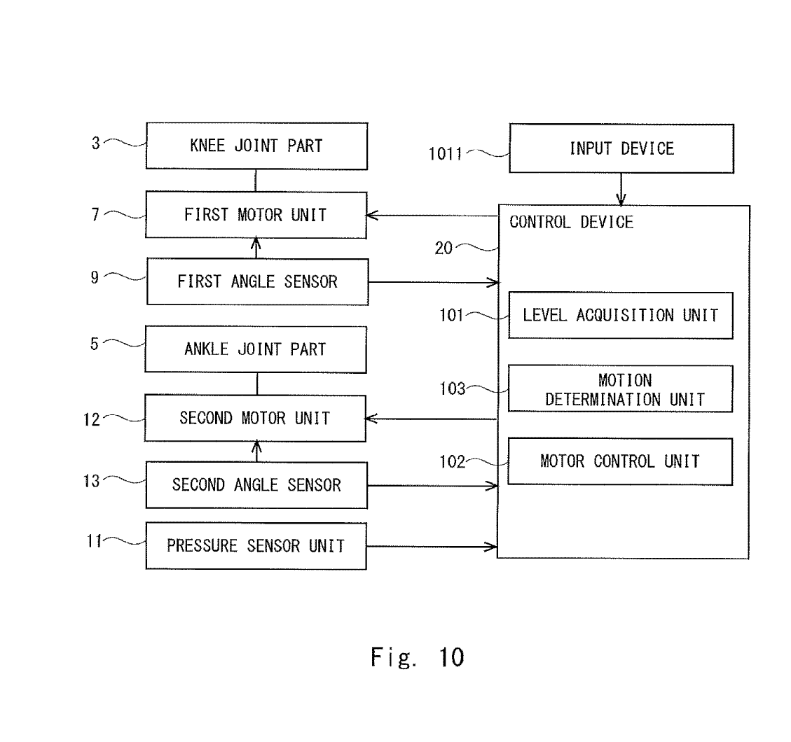

Next, a method for controlling the walking assistance apparatus according to the second embodiment is explained with reference to FIGS. 8 and 9.

The motion determination unit 103 determines, for example, whether the leg is in the leg-standing period or the leg-idling period based on a change in the knee joint angle over time detected by the first angle sensor 9 (FIG. 9) (step S201).

When the motion determination unit 103 determines that the leg is in the leg-idling period (step S202), the motor control unit 102 performs the first friction compensation control for the first motor unit 7 (step S203).

In the first friction compensation control, the motor control unit 102 calculates a mechanical friction force T_{f} in the knee joint part 3 based on the above-shown Expression (2). Then, the motor control unit 102 calculates a third driving force corresponding to the mechanical friction force T_{f} by multiplying the calculated mechanical friction force T_{f} by a predetermined coefficient. The motor control unit 102 controls the first motor unit 7 so that it generates a driving force that is obtained by adding the third driving force to the first driving force.

When the motion determination unit 103 determines that the leg is in the leg-standing period (step S204), the motor control unit 102 performs the second friction compensation control for the first motor unit 7 (step S205).

In the second friction compensation control, the motor control unit 102 calculates a mechanical friction force T_{f} in the knee joint part 3 based on the above-shown Expression (3). Then, the motor control unit 102 calculates a second or third driving force corresponding to the mechanical friction force T_{f} by multiplying the calculated mechanical friction force T_{f} by a predetermined coefficient. The motor control unit 102 controls the first motor unit 7 so that it generates a driving force f that is obtained based on the second or third driving force and the first driving force.

Note that in the second embodiment, the same symbols as those in the above-described first embodiment are assigned to the same components/parts as those in the first embodiment and their detailed explanations are omitted.

### Third Embodiment

FIG. 10 is a block diagram showing a schematic system configuration of a walking assistance apparatus according to a third embodiment of the present disclosure. A second motor unit 12 that rotationally drives the ankle joint part 5 is provided in the ankle joint part 5. A second angle sensor 13 that detects an ankle joint angle between the lower thigh frame 4 and the foot frame is provided in the ankle joint part 5. The second motor unit 12 is a specific example of the drive means.

The motor control unit 102 controls the driving of the second motor unit 12 based on the ankle joint angle output from the second angle sensor 13 and thereby assists the user's walking motion. The motor control unit 102 controls the second motor unit 12 so that it generates a fourth driving force and thereby assists the user's walking motion.

Note that similarly to the knee joint part 3 according to the above-described second embodiment, when the assisting level is low, i.e., equal to or lower than a predetermined level and hence the assisting force of the second motor unit 12 is small, the bending motion of the ankle joint part 5 is prevented (or reduced) due to a static friction force caused in the ankle joint part 5 at a timing at which the angular speed of the ankle joint part 5 becomes zero in the leg-standing period. As a result, the user is less likely to perceive a failure in his/her walking.

To cope with this, in the walking assistance apparatus according to the third embodiment, the motor control unit 102 controls the second motor unit 12 so that it generates a driving force that is obtained by reducing the fourth driving force by a fifth driving force corresponding to a static friction force caused in the ankle joint part 5 in a predetermined period which is within the leg-standing period of the walking motion and includes a timing at which the angular speed of the ankle joint part 5 (hereinafter referred to as an “ankle joint angular speed”) becomes zero when the assisting level acquired by the level acquisition unit 101 is equal to or lower than the predetermined level.

The motor control unit 102 performs friction compensation control for compensating for the friction force caused in the ankle joint part 5 for the second motor unit 12. The motor control unit 102 controls the second motor unit 12 so that it generates a driving force that is obtained by reducing the fourth driving force by a fifth driving force corresponding to mechanical friction in the ankle joint part 5.

When the motion determination unit 103 determines that the leg is in the leg-idling period, the motor control unit 102 performs first friction compensation control for the second motor unit 12. When the motion determination unit 103 determines that the leg is in the leg-standing period, the motor control unit 102 performs second friction compensation control for the second motor unit 12.

(I) First Friction Compensation Control

The motor control unit 102 calculates a mechanical friction force T′_{f} in the ankle joint part 5 based on the below-shown Expression (4) in which a kinetic friction force and a viscous friction force in the ankle joint part 5 are taken into consideration. The motor control unit 102 calculates a sixth driving force corresponding to the mechanical friction force T′_{f} by multiplying the calculated mechanical friction force T′_{f} by a predetermined coefficient. The motor control unit 102 controls the second motor unit 12 so that it generates a driving force that is obtained by adding the sixth driving force to the fourth driving force.

T′_{f}=T′_{dynamic}+K′_{f}θ′_{V}(θ′_{V}>ω_{f})

T′_{f}=−T′_{dynamic}+K′_{f}θ′_{V}(θ′_{V}<−ω_{f})

T′_{f}=0(−ω_{f}≦θ′_{V}≦ω_{f}) (4)

The term “T′_{dynamic}” is the kinetic friction force in the ankle joint part 5 and “K′_{f}θ′_{V}” is the viscous friction force in the ankle joint part 5. The constant “K′_{f}” is a viscous friction coefficient and “θ′_{V}” is an ankle joint angular speed. The plantarflexion direction of the ankle joint part 5 is defined as a positive direction and the dorsiflexion direction thereof is defined as a negative direction.

(II) Second Friction Compensation Control

The motor control unit 102 calculates a mechanical friction force T′_{f} in the ankle joint part 5 based on the below-shown Expression (5). The motor control unit 102 calculates a fifth or sixth driving force corresponding to the mechanical friction force T′_{f} by multiplying the calculated mechanical friction force T′_{f} by a predetermined coefficient. The motor control unit 102 controls the second motor unit 12 so that it generates a driving force that is obtained based on the fifth or sixth driving force and the fourth driving force.

T′_{f}=T′_{dynamic}±K′_{f}θ′_{V}(θ′_{V}>ω_{f})

T′_{f}=−T′_{dynamic}±K′_{f}θ′_{V}(θ′_{V}<−ω_{f})

T′_{f}=−F′_{static}(−ω_{f}≦θ′_{V}≦ω_{f}) and ((Assisting level)≦(Predetermined level))

T′_{f}=0(−ω_{f}≦θ′_{V}≦ω_{f}) and ((Assisting level)>(Predetermined level)) (5)

Note that in the third embodiment, the same symbols as those in the above-described first and second embodiments are assigned to the same components/parts as those in the first and second embodiments and their detailed explanations are omitted.

Note that the present disclosure is not limited to the above-described embodiments, and various modifications can be made without departing from the spirit and scope of the present disclosure.

In the above-described embodiments, the motor control unit 102 may perform at least one of the friction compensation control for the first motor unit 7 for the knee joint part 3 according to the above-described second embodiment and the friction compensation control for the second motor unit 12 for the ankle joint part 5 according to the above-described third embodiment.

In the present disclosure, the processes shown in FIG. 4 or 8, for example, can be implemented by causing a CPU to execute a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to third embodiments can be combined as desirable by one of ordinary skill in the art.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A walking assistance apparatus configured to be attached to a user's leg and assist a walking motion in which the leg repeats a leg-standing state and a leg-idling state, the walking assistance apparatus comprising:
a plurality of frames;
at least one leg joint part that connects each of the plurality of frames so that the frames can be rotationally moved relative to each other;
a drive unit that is configured to drive the leg joint part;
a controller that is configured to control the drive unit so that the drive unit generates a first driving force and thereby assists the walking motion; and
an acquisition unit that is configured to acquire an assisting level based on which a magnitude of an assisting force of the drive unit is determined when the walking motion is assisted, wherein
the controller controls the first driving force of the drive unit according to the assisting level acquired by the acquisition unit, and
the controller controls the drive unit so that the drive unit generates a driving force when the assisting level acquired by the acquisition unit is equal to or lower than a predetermined level, the driving force being obtained by reducing the first driving force by a second driving force corresponding to a friction force caused in the leg joint part.

2. The walking assistance apparatus according to claim 1, wherein the controller controls the drive unit so that the drive unit generates a driving force in a predetermined period when the assisting level acquired by the acquisition unit is equal to or lower than the predetermined level, the predetermined period being within a leg-standing period of the walking motion and including a timing at which an angular speed of the leg joint part becomes zero, the driving force being obtained by reducing the first driving force by a second driving force corresponding to a static friction force caused in the leg joint part.

3. The walking assistance apparatus according to claim 2, wherein the controller:
controls the drive unit so that the drive unit generates the first driving force in the predetermined period within a leg-idling period of the walking motion; and
controls the driving unit so that the drive unit generates a driving force in a period other than the predetermined period in the leg-standing period and the leg-idling period, the driving force being obtained by adding a third driving force corresponding to viscous friction and kinetic friction caused in the leg joint part to the first driving force.

4. The walking assistance apparatus according to claim 1, wherein the leg joint part is at least one of a knee joint part and an ankle joint part.

5. A control method for a walking assistance apparatus configured to be attached to a user's leg and assist a walking motion in which the leg repeats a leg-standing state and a leg-idling state, the walking assistance apparatus comprising:
a plurality of frames;
at least one leg joint part that connects each of the plurality of frames so that the frames can be rotationally moved relative to each other;
a drive unit that is configured to drive the leg joint part;
a controller that is configured to control the drive unit so that the drive unit generates a first driving force and thereby assists the walking motion; and
an acquisition unit that is configured to acquire an assisting level based on which a magnitude of an assisting force of the drive unit is determined when the walking motion is assisted in a stepwise manner, wherein
the controller controls the first driving force of the drive unit according to the assisting level acquired by the acquisition unit, and
the control method comprises controlling the drive unit so that the drive unit generates a driving force when the assisting level acquired by the acquisition unit is equal to or lower than a predetermined level, the driving force being obtained by reducing the first driving force by a second driving force corresponding to a friction force caused in the leg joint part.
